(19) United States
(12) Patent Application Publication
(10) Pub. No.: US 2015/0277592 A1
(43) Pub. Date: Oct. 1, 2015

(54) ELECTRONIC DEVICE AND ACTIVE STYLUS

(71) Applicant: KABUSHIKI KAISHA TOSHIBA, Tokyo (JP)

(72) Inventor: Nobutaka Nishigaki, Tokyo (JP)

(21) Appl. No.: 14/594,615

(22) Filed: Jan. 12, 2015

(30) Foreign Application Priority Data
Mar. 31, 2014 (JP) 2014-071050

(51) Int. Cl. G06F 3/0354; G06F 3/041

(52) U.S. Cl. CPC G06F 3/03545; G06F 3/041

(57) ABSTRACT

According to one embodiment, an electronic device includes a housing, a touch panel in the housing, a power transmitter in the housing, and an active stylus. The active stylus is capable of receiving power wirelessly from the power transmitter. The power transmitter includes a first coil to generate magnetic flux orthogonal to an upper surface of the housing for transmitting power. The active stylus includes one or more second coils for receiving power to resonate with the magnetic flux, at least one of the one or more second coils configured to be parallel to the first coil when the active stylus is in a first position or in a second position on the upper surface of the housing.

### CROSS-REFERENCE TO RELATED APPLICATIONS

This application is based upon and claims the benefit of priority from Japanese Patent Application No. 2014-071050, filed Mar. 31, 2014, the entire contents of which are incorporated herein by reference.

### FIELD

Embodiments described herein relate generally to an electronic device and an active stylus (active pen).

### BACKGROUND

Recently, portable battery-driven electronic devices such as a tablet device and a notebook personal computer (PC) have been widespread. Such electronic devices typically comprise a handwritten input function (stylus input function) so that a user can perform input operation easily.

There are various types of styluses of the handwritten input function such as an electromagnetic-type digitizer stylus, an active or passive stylus for use with an electrostatic-type touch panel, and a stylus for use with a resistive film-type touch panel.

An active stylus is promising in the future since the active stylus recently becomes more accurate and the use thereof realizes a palm rejection function. However, an active stylus needs to be equipped with a battery and therefore cannot be used when out of charge.

Further, the size of a battery needs to be limited due to the shape of a stylus. While a battery can be a primary battery, a secondary battery and an electric double-layer capacitor, both advantages and disadvantages exist in size, weight and battery life. For example, by using an electric double-layer capacitor, it is possible to make a stylus smaller in diameter and lighter but the battery life gets shorter.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary exterior view of a tablet device and an active stylus constituting a wireless power-transmission system of the embodiment.

FIG. 2 is an exemplary diagram illustrating a system configuration of the tablet device of the embodiment.

FIG. 3 is an exemplary diagram illustrating a system configuration of the active stylus of the embodiment.

FIG. 4 is an exemplary drawing illustrating an example where a power-transmitting coil in the tablet device of the embodiment is arranged.

FIG. 5 is an exemplary drawing illustrating an example where a power-receiving coil in the active stylus of the embodiment is arranged.

FIG. 6 is an exemplary drawing for explaining a desirable positional relationship between the power-transmitting coil of the tablet device and the power-receiving coil of the active stylus of the embodiment.

FIG. 7 is an exemplary drawing for explaining a first arrangement pattern of the power-receiving coil in the active stylus of the embodiment.

FIG. 8 is an exemplary drawing illustrating that the active stylus is placed on the tablet device of the embodiment.

FIG. 9 is an exemplary drawing for explaining a second arrangement pattern of the power-receiving coil in the active stylus of the embodiment.

FIG. 10 is an exemplary drawing for explaining a third arrangement pattern of the power-receiving coil in the active stylus of the embodiment.

FIG. 11 is an exemplary drawing for explaining a fourth arrangement pattern of the power-receiving coil in the active stylus of the embodiment.

FIG. 12 is an exemplary drawing illustrating that the active stylus is placed in a side surface portion of the tablet device of the embodiment.

FIG. 13 is an exemplary drawing illustrating a positional relationship between the power-transmitting coil of the tablet device and the power-receiving coil of the active stylus when the active stylus is placed in the side surface portion of the tablet device of the embodiment.

FIG. 14 is an exemplary drawing that power is transmitted wirelessly from the tablet device to the active stylus during a handwritten input operation of the embodiment.

### DETAILED DESCRIPTION

Various embodiments will be described hereinafter with reference to the accompanying drawings.

In general, according to one embodiment, an electronic device comprises a housing, a touch panel in the housing, a power transmitter in the housing, and an active stylus. The active stylus is capable of receiving power wirelessly from the power transmitter. The power transmitter comprises a first coil to generate magnetic flux orthogonal to an upper surface of the housing for transmitting power. The active stylus comprises one or more second coils for receiving power to resonate with the magnetic flux, at least one of the one or more second coils configured to be parallel to the first coil when the active stylus is in a first position or in a second position on the upper surface of the housing.

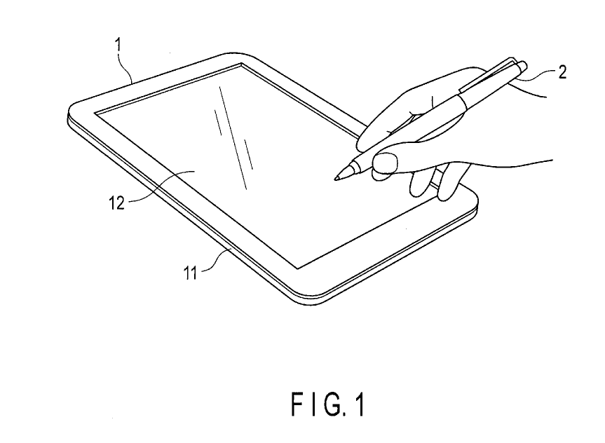

FIG. 1 is an exemplary exterior view of a tablet device 1 and an active stylus 2 constituting the wireless power-transmission system of the embodiment. The wireless power-transmission system wirelessly supplies power (wirelessly transmits power) from the tablet device 1 to the active stylus 2 by use of a magnetic field resonant coupling mode or a direct-current-resonance mode.

As shown in FIG. 1, the tablet device 1 comprises a main body 11 and a touch screen display 12. The touch screen display 12 is overlappingly attached to the upper surface of the main body 11.

The main body 11 has a thin box-shaped housing. The touch screen display 12 is equipped with a flat panel display and a sensor that detects a contact position of the active stylus 2 on the flat panel display. The sensor is an electrostatic-type touch panel and comprises a function to support the active stylus 2. The flat panel display is, for example, a liquid crystal display (LCD). The touch panel is arranged so as to cover the screen of the flat panel display.

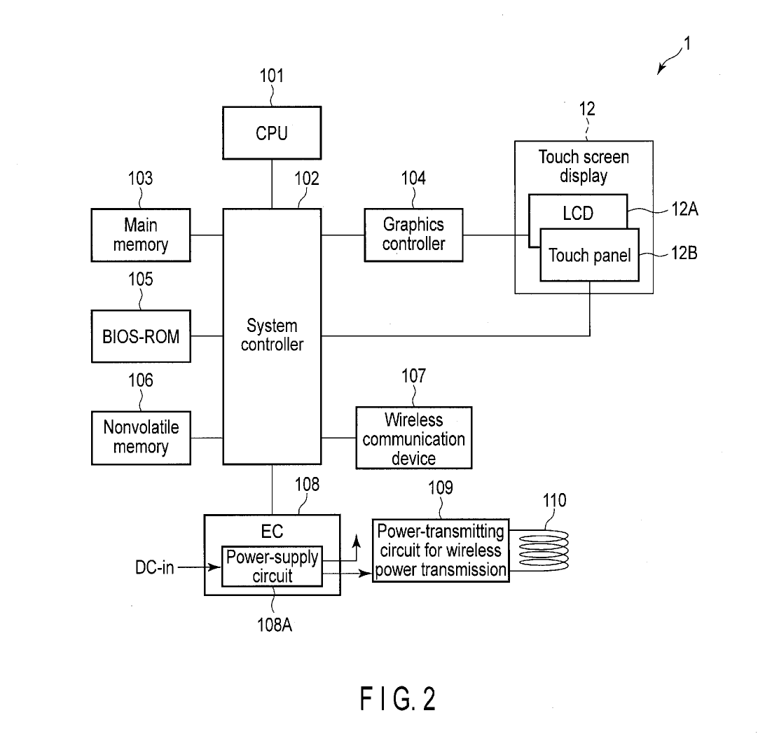

FIG. 2 is an exemplary diagram illustrating the system configuration of the tablet device 1.

As shown in FIG. 2, the tablet device 1 comprises a CPU 101, a system controller 102, a main memory 103, a graphics controller 104 and a BIOS-ROM 105. The tablet device 1 also comprises a nonvolatile memory 106, a wireless communication device 107, an embedded controller (EC) 108, a power-transmitting circuit for wireless power transmission 109 and a power-transmitting coil 110.

The CPU 101 is a processor that controls the operation of each of modules in the tablet device 1. The CPU 101 loads each of software from the nonvolatile memory 106 to the main memory 103 and executes it. The CPU 101 also executes a basic input/output system (BIOS) stored in the BIOS-ROM 105. The BIOS is a program for controlling hardware.

The system controller 102 is a device that connects the local bus of the CPU 101 and each of components. The system controller 102 is equipped with a memory controller that accesses and controls the main memory 103. Also, the system controller 102 comprises a function to execute communication with the graphics controller 104 via a serial bus conforming to the PCI EXPRESS standard, etc.

The graphics controller 104 is a display controller that controls an LCD 12A used as a display monitor of the tablet device 1. The LCD 12A displays a screen image based on a display signal generated by the graphics controller 104. On the LCD 12A is arranged a touch panel 12B. The touch panel 12B is an electrostatic-type pointing device for performing input on the screen of the LCD 12A. A position on which the active stylus 2 contacts is detected by the touch panel 12B.

The wireless communication device 107 is a device that executes wireless communication such as wireless LAN and 3G mobile communication. The EC 108 is a single-chip micro computer comprising a power circuit 108A for power management. The EC 108 comprises a function to power on/off the tablet device 1 in accordance with the operation of a power button by a user.

The power-transmitting circuit for wireless power transmission 109 is a circuit that transmits power from the power circuit 108A to the active stylus 2 by use of the power-transmitting coil 110. The power-transmitting coil 110 is a coil that generates magnetic flux for resonating the power-receiving coil of the active stylus 2 under control of the power-transmitting circuit for wireless power transmission 109.

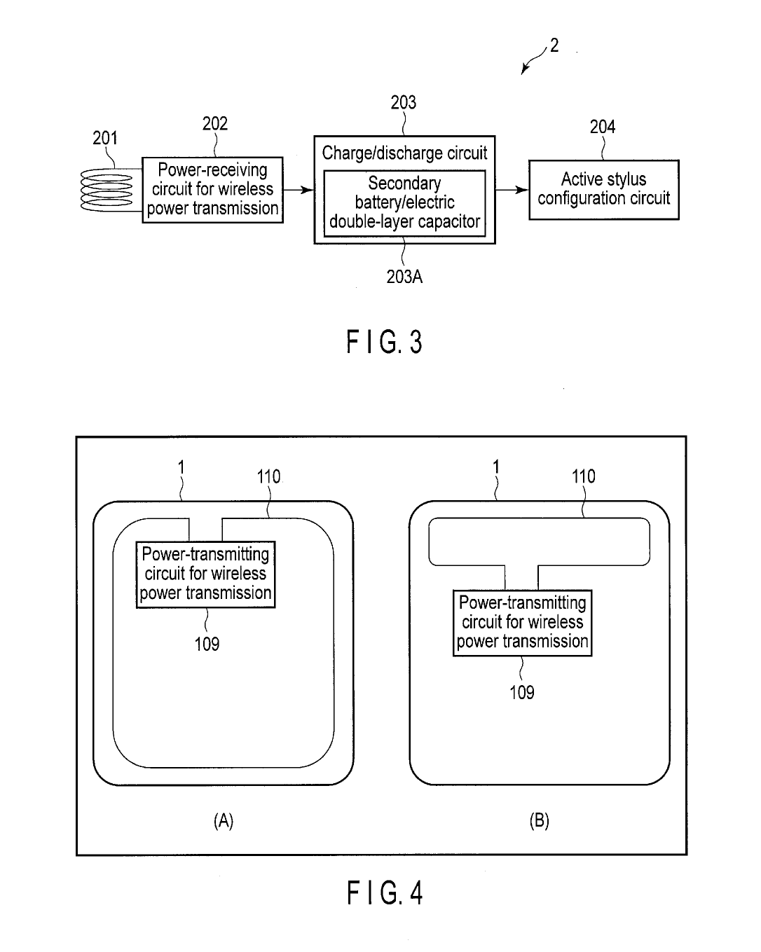

FIG. 3 is an exemplary diagram illustrating the system configuration of the active stylus 2.

As shown in FIG. 3, the active stylus 2 comprises a power-receiving coil 201, a power-receiving circuit for wireless power transmission 202, a charge/discharge circuit 203 and an active stylus configuration circuit 204.

The power-receiving coil 201 is a coil that generates power by resonating by magnetic flux from the power-transmitting coil 110 of the tablet device 1. The power-receiving circuit for wireless power transmission 202 is a circuit that stabilizes power generated by the power-receiving coil 201 and supplies it to the charge/discharge circuit 203. The charge/discharge circuit 203 is a circuit that comprises a secondary battery or an electric double-layer capacitor (hereinafter referred to as secondary battery/electric double-layer capacitor 203A). The charge/discharge circuit 203 charges the secondary battery/electric double-layer capacitor 203A with power supplied from the power-receiving circuit for wireless power transmission 202 and supplies the power of the secondary battery/electric double-layer capacitor 203A to the active stylus configuration circuit 204 as power for operation. Thus, the active stylus 2 functions as an input device upon the active stylus configuration circuit 204 operates by use of the secondary battery/electric double-layer capacitor 203A as a power source, and the secondary battery/electric double-layer capacitor 203A is charged with power from the power circuit 108A of the tablet device 1. In the wireless power-transmission system, the arrangement of the power-receiving coil 201 is devised so that power transmitted from the tablet device 1 is efficiently received in the active stylus 2, which will be described in detail later.

FIG. 4 is an exemplary drawing illustrating an example where the power-transmitting coil 110 in the tablet device 1 is arranged. In FIG. 4, it is assumed in both (A) and (B) that the inside of the tablet device 1 is viewed from the upper portion of the tablet device 1.

In FIG. 4, (A) illustrates an example where the power-transmitting coil 110 is arranged so as to encircle the whole region of the upper surface of the main body 11, with which the touch screen display 12 is overlapped. On the other hand, (B) illustrates an example where the power-transmitting coil 110 is arranged so as to encircle a partial region of the upper surface of the main body 11, with which the touch screen display 12 is overlapped. In either (A) or (B), magnetic flux orthogonal to the upper surface of the main body 11 with which the touch screen display 12 is overlapped is generated in a region encircled by the power-transmitting coil 110. In the following, an orientation that a region encircled by a coil faces is referred to as a coil orientation.

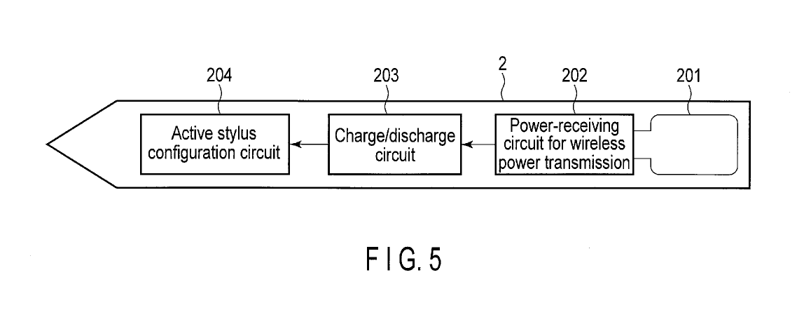

FIG. 5 is an exemplary drawing illustrating an example where the power-receiving coil 201 in the active stylus 2 is arranged. It is assumed that the inside of the active stylus 2 is viewed from the side surface portion of the active stylus 2.

As shown in FIG. 5, the power-receiving coil 201 is arranged in, for example, the rear end portion of the active stylus 2 so that the region encircled by the power-receiving coil 201 faces a direction (direction of the side surface portion) orthogonal to the axis of the active stylus 2. That is, the power-receiving coil 201 is arranged in an orientation orthogonal to the axis of the active stylus 2. While it is exemplified that the power-receiving coil 201 is arranged in the rear end portion of the active stylus 2, where a space is likely to be secured, it is not limited thereto; if there is a space, the power-receiving coil 201 may be arranged in the center end portion or the front portion of the active stylus 2.

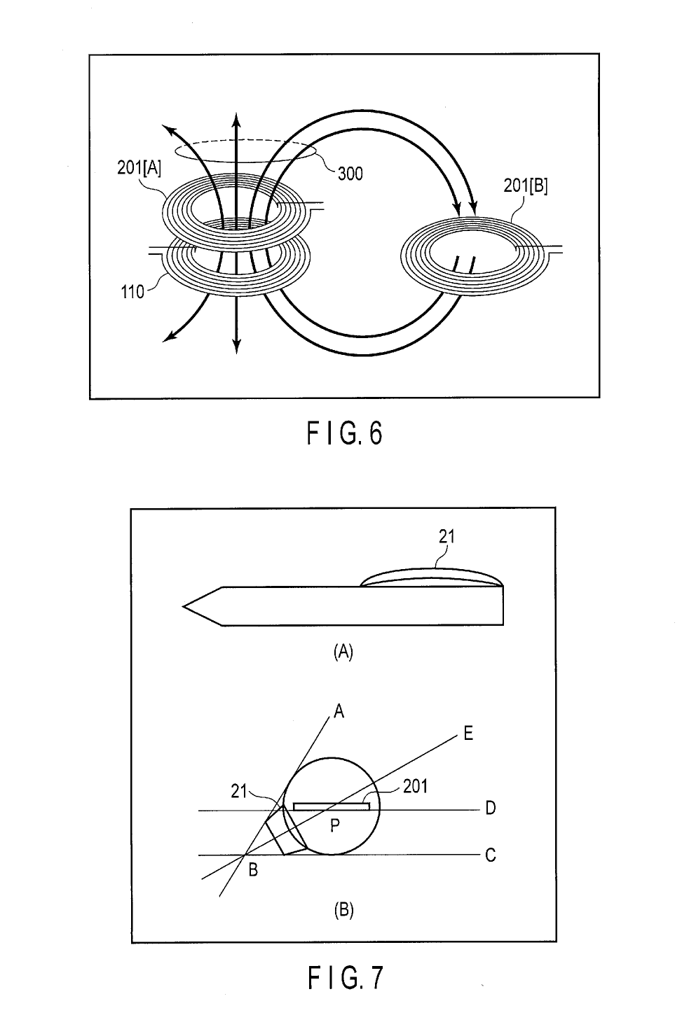

The orientation of the power-receiving coil 201 arranged as shown in FIG. 5 varies depending on how the active stylus 2 is placed (with the axis horizontal [tilted]). Next, in view of this, the desirable positional relationship between the power-transmitting coil 110 of the tablet device 1 and the power-receiving coil 201 of the active stylus 2 will be described with reference to FIG. 6.

In FIG. 6, reference number 300 represents magnetic flux generated by the power-transmitting coil 110 of the tablet device 1. It is desirable that the power-receiving coil 201 of the active stylus 2 exist in an orientation perpendicularly intersecting the magnetic flux 300. Typically, on the region encircled by the power-transmitting coil 110, it is possible to place the power-receiving coil 201 (power-receiving coil 201 [A]) in an orientation perpendicularly intersecting the magnetic flux 300 generated by the power-transmitting coil 110, by being positioned in the same orientation as the power-transmitting coil 110, i.e., in parallel with the power-transmitting coil 110. It is also possible to place the power-receiving coil 201 in an orientation perpendicularly intersecting the magnetic flux 300 generated by the power-transmitting coil 110, by being positioned on a line horizontal to the power-transmitting coil 110 (power-receiving coil 201 [B]).

As described above, the power-transmitting coil 110 of the tablet device 1 is arranged so as to generate magnetic flux orthogonal to the upper surface of the main body 11, with which the touch screen display 12 is overlapped. In other words, the power-transmitting coil 110 is arranged in an orientation orthogonal to the screen of the touch screen display 12. The wireless power-transmission system makes the power-receiving coil 201 of the active stylus 2 parallel to the power-transmitting coil 110 of the tablet device 1 when the active stylus 2 is placed on the touch screen display 12. Further, even when the active stylus 2 is placed in the peripheral portion of the tablet device 1, the wireless power-transmission system makes it possible to efficiently receive power transmitted from the tablet device 1 by arranging the power-receiving coil 201 so as to be positioned on a line horizontal to the power-transmitting coil 110, if the active stylus 2 is placed on a position where the amount of magnetic flux from the power-transmitting coil 110 intersecting the power-receiving coil 201 is sufficient.

(Pattern 1)

To begin with, the first arrangement pattern of the power-receiving coil 201 in the active stylus 2 will be described with reference to FIG. 7.

As shown in (A) of FIG. 7, it is assumed that a clip portion 21 is attached to the active stylus 2. It is also assumed that the main body portion of the active stylus 2 is cylindrical.

For example, when placed on the touch screen display 12 of the tablet device 1, the active stylus 2 rotates around its axis to make the clip portion 21 contact the touch screen display 12. (B) of FIG. 7 is an exemplary cross-sectional view (orthogonal to the axis) in the clip portion 21 of the active stylus 2.

When the screen of the touch screen display 12 is referred to as line C, line C is contacted by the main body portion of the active stylus 2 and the clip portion 21. A state where the clip portion 21 contacts the touch screen display 12 includes two possible states: one is that the left end portion of the clip portion 21 contacts the touch screen display 12; and the other is that the right end portion of the clip portion 21 contacts the touch screen display 12. Line A represents the screen of the touch screen display 12 on the assumption that the touch screen display 12 is contacted by the end portion opposite the clip portion 21. The intersection point of these two lines A and C is referred to as B.

In addition, the center of the cross-section, i.e., axis, of the active stylus 2 is referred to as P, and a line including segment BP is referred to as line E. A line including the cross-section of the power-receiving coil 201 (a surface orthogonal to the orientation of the power-receiving coil 201) is referred to as line D.

At this time, the power-receiving coil 201 is arranged to make line D parallel to line C so that the relationship of the following formula (1) is satisfied:

∠ABC=2PBC=2∠EPD formula (1)

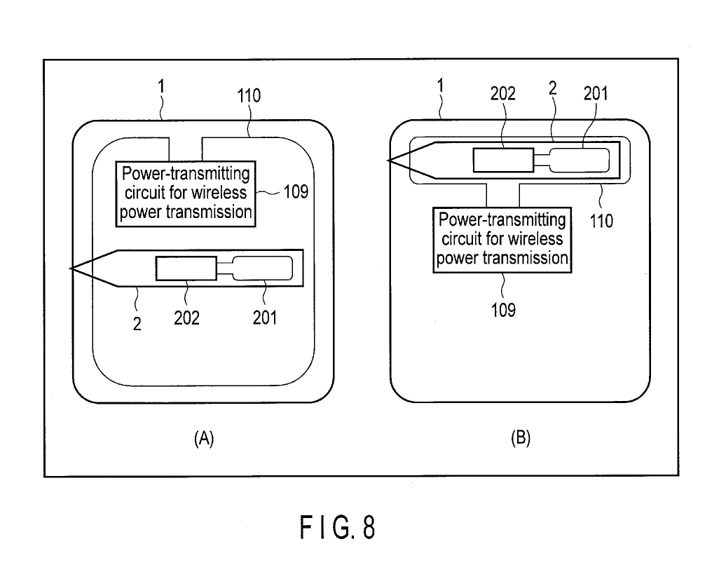

When the active stylus 2 is placed on the touch screen display 12 of the tablet device 1 as shown in FIG. 8, for example, line C is more likely to be contacted by the main body portion and the clip portion 21 of the active stylus 2, by arranging the power-receiving circuit for wireless power transmitting 202, the charge/discharge circuit 203 and the active stylus configuration circuit 204 in view of weight balance.

When the active stylus 2 in which the power-receiving coil 201 is thus arranged is placed on the touch screen display 12 of the tablet device 1 as shown in FIG. 8, for example, the power-transmitting coil 110 of the tablet device 1 is positioned parallel to the power-receiving coil 201 of the active stylus 2. Therefore, power transmitted from the tablet device 1 is efficiently received in the active stylus 2.

Accordingly, for example, when using the active stylus 2, it is possible to operate the active stylus 2 while transmitting power only by placing the active stylus 2 on the touch screen display 12 of the tablet device 1 during a handwritten input operation.

Even if line A is contacted by the main body portion and the clip portion 21 of the active stylus 2 as shown in (B) of FIG. 7, the power-transmitting coil 110 of the tablet device 1 is not positioned orthogonal to the power-receiving coil 201 of the active stylus 2. This never leads to a situation where power transmitted from the tablet device 1 is not received at all by the active stylus 2.

(Pattern 2)

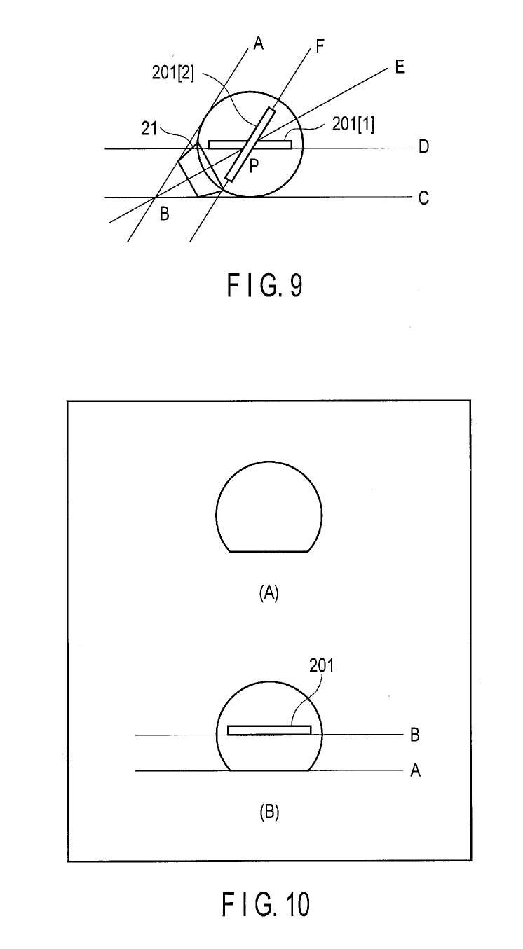

Next, the second arrangement pattern of the power-receiving coil 201 in the active stylus 2 will be described with reference to FIG. 9.

As with the above-mentioned first arrangement pattern, it is assumed that the clip portion 21 is attached to the active stylus 2 and that the main body portion of the active stylus 2 is cylindrical, as shown in (A) of FIG. 7. In the second arrangement pattern, two power-receiving coils 201 [1] and [2] are arranged in the active stylus 2.

In FIG. 9, the power-receiving coil 201 [1] is the power-receiving coil 201 arranged in the same way as the above-mentioned first arrangement pattern and the power-receiving coil 201 [2] is the power-receiving coil 201 arranged in addition to the above-mentioned first arrangement pattern. A line including the cross-section of the power-receiving coil 201 [2] (a surface orthogonal to the orientation of the power-receiving coil 201 [2]) is referred to as line F.

At this time, the power-receiving coils 201 [1] and [2] are arranged to make line D parallel to line C and to make line F parallel to line A so that the relationship of the following formula (2) is satisfied:

∠ABC=2∠PBC=2∠EPD=2∠EPF formula (2)

When the active stylus 2 in which the power-receiving coils 201 [1] and [2] are thus arranged is placed on the touch screen display 12 of the tablet device 1 as shown in FIG. 8, for example, the power-transmitting coil 110 of the tablet device 1 is positioned parallel to one of the power-receiving coils 201 [1] and [2] of the active stylus 2, when either line A or C is contacted by the main body portion and the clip portion 21. Therefore, power transmitted from the tablet device 1 is efficiently received in the active stylus 2.

Accordingly, for example, when using the active stylus 2, it is possible to operate the active stylus 2 while transmitting power only by placing the active stylus 2 on the touch screen display 12 of the tablet device 1 during a handwritten input operation.

If a plurality of power-receiving coils 201 are arranged in the active stylus 2, all of the power-receiving coils may be connected to the power-receiving circuit for wireless power transmission 202, or, for example, one of them may be connected to the power-receiving circuit for wireless power transmission 202. The power-receiving coils 201 that are not connected to the power-receiving circuit for wireless power transmission 202 play a role in resonating the power-receiving coils 201 that are connected to the power-receiving circuit for wireless power transmission 202.

(Pattern 3)

Subsequently, the third arrangement pattern of the power-receiving coil 201 in the active stylus 2 will be described with reference to FIG. 10.

(A) of FIG. 10 is a cross-sectional view (orthogonal to the axis) of the active stylus 2. As shown in (A) of FIG. 10, it is assumed that a surface parallel to the axis direction is formed in the side surface portion of the active stylus 2.

The active stylus 2 is usually placed with the surface formed in the side surface portion downward so that the stylus does not roll over. Alternatively, the active stylus 2 rotates on its axis, with the surface formed in the side surface portion downward. That is, for example, when the active stylus 2 is placed on the touch screen display 12 of the table device 1, the surface formed in the side surface portion contacts the touch screen display 12.

In (B) of FIG. 10, line A represents the screen of the touch screen display 12 and line B represents a line including the cross-section of the power-receiving coil 201 (a surface orthogonal to the orientation of the power-receiving coil 201). At this time, the power-receiving coil 201 is arranged so that line B is parallel to line A.

When the active stylus 2 in which the power-receiving coil 201 is thus arranged is placed on the touch screen 12 of the tablet device 1 as shown in FIG. 8, for example, the power-transmitting coil 110 of the tablet device 1 is positioned parallel to the power-receiving coil 201 of the active stylus 2. Therefore, power transmitted from the tablet device 1 is efficiently received in the active stylus 2.

Accordingly, for example, when using the active stylus 2, it is possible to operate the active stylus 2 while transmitting power only by placing the active stylus 2 on the touch screen display 12 of the tablet device 1 during a handwritten input operation.

(Pattern 4)

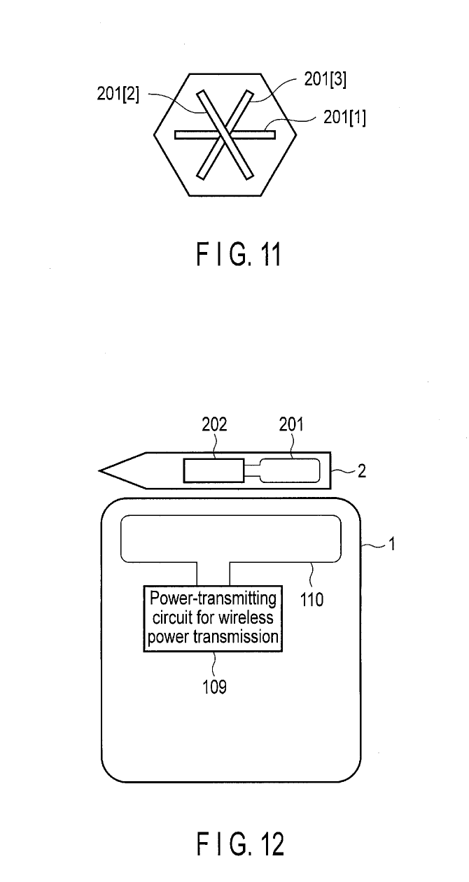

Then, the fourth arrangement pattern of the power-receiving coil 201 in the active stylus 2 will be described with reference to FIG. 11.

FIG. 11 is an exemplary cross-sectional view (orthogonal to the axis) of the active stylus 2. That is, it is assumed that the active stylus 2 has the shape of a hexagonal prism.

When the active stylus 2 is placed on the touch screen 12 of the tablet device 1, for example, any one of six surfaces formed in the side surface portion contacts the touch screen display 12.

Therefore, as shown in FIG. 11, three power-receiving coils 201 are arranged so that each power-receiving coil 201 is parallel to each surface formed in the side surface portion. More specifically, each one of the receiving coils 201 is parallel to each of three pairs of opposing surfaces in the six surfaces formed in the side surface portion.

When the active stylus 2 is placed on the touch screen 12 of the tablet device 1 as shown in FIG. 8, for example, even if any of the surfaces contacts the touch screen display 12, the power-transmitting coil 110 of the tablet device 1 is positioned parallel to any one of the power-receiving coils 201 of the active stylus 2. Therefore, power transmitted from the tablet device 1 is efficiently received in the active stylus 2.

Accordingly, for example, when using the active stylus 2, it is possible to operate the active stylus 2 while transmitting power only by placing the active stylus 2 on the touch screen display 12 of the tablet device 1 during a handwritten input operation.

In the above-mentioned case, the active stylus 2 is placed on the touch screen display 12 of the tablet device 1 as shown in FIG. 8. In the following case, the active stylus 2 is placed in the side surface portion of the tablet device 1 as shown in, for example, FIG. 12.

When the active stylus 2 which has been described above is placed on, for example, the same table as the one on which the tablet device 1 is placed, the power-transmitting coil 110 of the tablet device 1 is positioned parallel to the power-receiving coil 201 of the active stylus 2. Also, as described with reference to FIG. 6, the power-receiving coil 201 can be positioned in an orientation perpendicularly intersecting the magnetic flux 300 generated by the power-transmitting coil 110 by positioning the active stylus 2 on a line horizontal to the power-transmitting coil 110 (if the active stylus 2 is placed on a position where the amount of magnetic flux from the power-transmitting coil 110 intersecting the power-receiving coil 201 is sufficient).

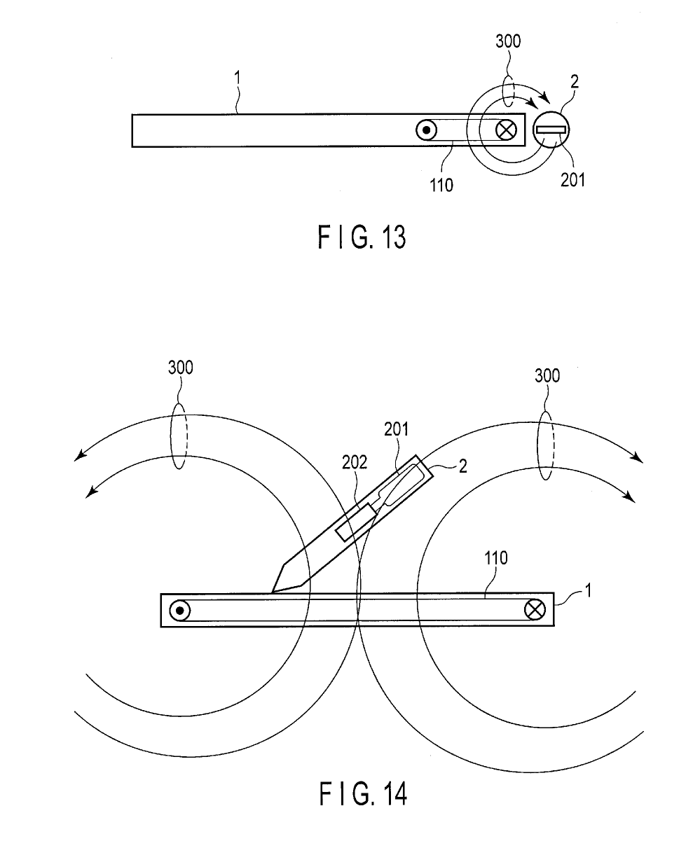

Therefore, as shown in FIG. 13, power transmitted from the tablet device 1 can be efficiently received by the active stylus 2, further by arranging the power-receiving coil 201 in the active stylus 2 so as to be positioned on a line horizontal to the power-transmitting coil 110.

For example, when an accommodation portion for accommodating the active stylus 2 is provided in the housing side surface portion of the tablet device 1 and the active stylus 2 is accommodated in this accommodation portion, the power-receiving coil 201 may be positioned on a line horizontal to the power-transmitting coil 110. Also, when both the tablet device 1 and the active stylus 2 are accommodated in a cover, a holder or the like that can accommodate them, the power-receiving coil 201 may be positioned on a line horizontal to the power-transmitting coil 110.

As shown in, for example, FIG. 14, an angle and a distance are made between the power-transmitting coil 110 and the power-receiving coil 201 on the touch screen display 12 of the tablet device 1, during a handwritten input operation by use of the active stylus 2. Therefore, the amount of magnetic flux from the power-transmitting coil 110 intersecting the power-receiving coil 201 decreases and the power-transmission efficiency decreases. However, if the amount of operating power of the active stylus 2 is equivalent to or smaller than the amount of receiving power, the active stylus 2 can be operated or can charge the secondary battery/electric double-layer capacitor 203A by power transmitted from the tablet device 1.

As described above, the wireless power-transmission system realizes operating a stylus while transmitting power.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a housing;
a touch panel in the housing;
a power transmitter in the housing; and
an active stylus capable of receiving power wirelessly from the power transmitter, wherein:
the power transmitter comprises a first coil to generate magnetic flux orthogonal to an upper surface of the housing for transmitting power; and
the active stylus comprises one or more second coils for receiving power to resonate with the magnetic flux, at least one of the one or more second coils configured to be parallel to the first coil when the active stylus is in a first position or in a second position on the upper surface of the housing.

2. The electronic device of claim 1, wherein,
the active stylus further comprises a main body portion and a clip portion wherein:
the active stylus is in the first position when both the main body portion and the clip portion are touching on the upper surface of the housing.

3. The electronic device of claim 2, wherein,
the active stylus is in a second position, the second position different from the first position, when both the main body portion and the clip portion are touching on the upper surface of the housing.

4. The electronic device of claim 1, wherein:
the active stylus receives the power generated by the first coil when the active stylus is in the first or the second position placed on the upper surface of the housing where the power transmitter is located in the housing.

5. The electronic device of claim 4, the active stylus further comprises:
a shape of a prism having n faces;
at least one of the one or more second coils configured to be parallel to each of the n faces of the prism; and
at least one of the n faces intersecting the magnetic flux, wherein the prism has n positions to be placed on the upper surface of the housing to receive the power generated by the first coil and n is more than or equal to three.

6. The electronic device of claim 1, the active stylus further comprises:
a secondary battery or an electric double-layer capacitor; and
a power-receiving circuit to receive power wirelessly from the power transmitter and to charge the secondary battery or the electric double-layer capacitor, wherein
at least one of the one or more second coils are connected to the power-receiving circuit, and the second coils not connected to the power-receiving circuit resonate with the second coils connected to the power-receiving circuit.

7. The electronic device of claim 4, wherein at least one of the one or more second coils are configured to intersect the magnetic flux generated by the first coil when the active stylus is placed in the first or second position on the upper surface of the housing where the power transmitter is located in the housing.

8. An active stylus for a handwritten input operation on a touch panel device, comprising,
a power receiver to wirelessly receive power from the touch panel device comprises one or more second coils for receiving power by resonating with magnetic flux generated by a first coil located in the touch panel, wherein at least one of the one or more second coils are configured to intersect the magnetic flux when the active stylus is in a first position or in a second position on the touch panel device.

9. The active stylus of claim 8, further comprising a main body portion and a clip portion,
wherein the active stylus is in the first position when both the main body portion and the clip portion are touching on the touch panel.

10. The active stylus of claim 8, wherein the active stylus is in the second position different from the first position when both the main body portion and the clip portion are touching on the touch panel device.

11. The active stylus of claim 8, wherein:
the active stylus receives the power generated by the first coil when the active stylus is in the first or the second position placed on the touch panel device where the first coil is located under the touch panel.

12. The active stylus of claim 8, further comprising:
a shape of a prism having n faces;
at least one of the one or more second coils configured to be parallel to each of the n faces of the prism; and
at least one of the n faces intersecting the magnetic flux to receive the power from the first coil when one of the n faces is place on the touch panel device, wherein n is more than or equal to three.

13. The active stylus of claim 8, further comprising:
a secondary battery or an electric double-layer capacitor; and
a power-receiving circuit to receive power wirelessly from the touch panel device and to charge the secondary battery or the electric double-layer capacitor,
wherein at least one of the one or more second coils are connected to the power-receiving circuit, and the second coils not connected to the power-receiving circuit resonate with the second coils connected to the power-receiving circuit.

14. The active stylus of claim 8, wherein at least one of the one or more second coils are configured to intersect the magnetic flux generated by the first coil when the active stylus is placed in the first or second position on the touch panel device where the first coil is located under the touch panel.
